(19) United States
(12) Patent Application Publication
(10) Pub. No.: US 2025/0215213 A1
(43) Pub. Date: Jul. 3, 2025

(54) MULTICOMPONENT FILM

(71) Applicant: Eastman Chemical Company, Kingsport, TN (US)

(72) Inventors: Steven R. Givens, Kingsport, TN (US); Sophie Ann Ruddick, Liverpool (GB); Brandon Robert Williamson, Johnson City, TN (US); Glen I. Petrie, Oregon, WI (US)

(73) Assignee: Eastman Chemical Company, Kingsport, TN (US)

(21) Appl. No.: 18/848,287

(22) PCT Filed: Mar. 14, 2023
(86) PCT No.: PCT/US2023/064273

§ 371 Date: Sep. 18, 2024

Related U.S. Application Data
(60) Provisional application No. 63/269,649, filed on Mar. 21, 2022.

(51) Int. Cl. C08L 67/02; A61C 7/08

(52) U.S. Cl. CPC C08L 67/025; A61C 7/08; C08L 2203/16; C08L 2205/025; C08L 2207/53

(57) ABSTRACT

Provided are copolyester films comprising multicomponent compositions which exhibit improved durability and customizable modulus properties which can be useful in many applications, including formed articles for use in the dental appliance market.

### FIELD OF THE INVENTION

This invention belongs generally to the field of thermoplastic polymers. In particular, it relates to polymeric films useful in the manufacture three dimensional thermoformed articles, such as dental appliances.

### BACKGROUND OF THE INVENTION

Traditionally, metal braces have been used to reposition teeth for improved function or appearance. In recent years, metal braces have been supplanted in many cases by plastic aligners. Aligners are thermoformed appliances which fit over the patient's teeth, designed to gradually move them to a desired position. Aligners must be stiff enough to exert an initial force on the teeth, able to maintain a sufficient force over a period of time and be durable (resist cracking).

Aligners can be made from a monolayer plastic sheet, but multilayer sheet (consisting of two or more distinct layers of plastic) can allow more freedom to tailor properties to specific needs. However, multilayer sheet manufacturing processes can be more difficult or cost-intensive than a monolayer counterpart and may also have limited ability to tailor properties of the sheet.

It would be beneficial to provide films or sheets having improved or a wider latitude for tailoring properties compared to current monolayer or multilayer sheets.

### SUMMARY OF THE INVENTION

It has been discovered that a multicomponent (e.g., monolayer) film (comprising two or more distinct polymers) may allow more freedom to tailor properties to specific needs. In embodiments, a monolayer film can be provided that allows more freedom to tailor properties to specific needs without the added complexity of multilayer film extrusion. In other embodiments, a multilayer film can be provided that allows more freedom to tailor properties to specific needs than multilayer films that utilize essentially single polymer layers.

It has also been found that blending different polymers in a structure having one dominant (or majority) polymer domain with a suitably chosen minority component (in the same film/layer) allows the ability to tailor the overall structure's physical properties that are desirable for a specific application (for example, flexural modulus, tear properties, and stress relaxation).

The invention is as set forth in the appended claims. In general, the invention relates to film structures which exhibit improved durability and customizable modulus properties which can be useful in many applications, including thermoformed articles for use in the dental appliance market. The modulus can be tailored to fit the needs of the end user by altering the material selection and the thickness of the film or layer(s). These structures can be produced through extrusion, lamination, or other means known to those skilled in the art.

In an aspect, film structures are provided that comprise a multicomponent composition. In embodiments, the multicomponent composition comprises at least two polymer components (A) and (B) that are different. In embodiments, polymer component (A) is present in an amount from 50 to 99 wt %, or greater than 50 to 99 wt %, and polymer component (B) is present in an amount from 1 to 50 wt %, or 1 to less than 50 wt %. In embodiments, the film is a monolayer structure. In other embodiments, the film is a multilayer structure that comprises one or more layers that comprises a multicomponent composition.

### DETAILED DESCRIPTION OF THE INVENTION

The term “film”, as used herein, includes both film and sheet, and is intended to have its commonly accepted meaning in the art.

As used herein, the singular forms “a”, “an”, and “the” include their plural referents unless the context clearly dictates otherwise. The terms “containing” or “including” are intended to be synonymous with the term “comprising”, meaning that at least the named compound, element, particle, or method step, etc., is present in the composition or article but does not exclude the presence of other compounds, materials, method steps, etc., even if the other such compounds, material, particles, method steps, etc., have the same function as what is named, unless expressly excluded in the claims.

In an aspect, a film is provided that comprises a multicomponent composition, said multicomponent composition comprising at least two polymeric components (A) and (B), wherein polymeric component (A) is present in an amount from greater than 50 to 99 wt % and polymeric component (B) is present in an amount from 1 to less than 50 wt %. In embodiments, the polymeric component (A) comprises a polyester that comprises:
(a) a dicarboxylic acid component comprising:
   i) 70 to 100 mole % of terephthalic acid residues; and
   ii) 0 to 30 mole % of aromatic and/or aliphatic dicarboxylic acid residues having up to 20 carbon atoms; and
(b) a glycol component comprising:
   i) 10 to 50 mole % of 2,2,4,4-tetramethyl-1,3-cyclobutanediol residues;
   ii) 0 to 90 mole % of 1,4-cyclohexanedimethanol residues; and
   iii) 0 to 90 mole % of ethylene glycol residues; and
having an inherent viscosity of about 0.4 to about 0.9 dL/g as determined in 60/40 (wt/wt) phenol/tetrachloroethane at a concentration of 0.5 g/100 ml at 25° C.; and
polymeric component (B) comprises a polyester which is other than the polyester in polymeric component (A).

In embodiments, polymeric component (B) comprises a polyester that comprises: (a) a dicarboxylic acid component comprising residues of 1,4-cyclohexane dicarboxylate, and (b) a diol component comprising residues of 1,4-cyclohexanedimethanol.

In embodiments, polymeric component (B) comprises a polyester that comprises:
(a) a dicarboxylic acid component comprising:
   i) 90 to 100 mole % of 1,4-cyclohexane dicarboxylic acid residues;
   ii) 0 to 10 mole % of aromatic and/or aliphatic dicarboxylic acid residues having up to 20 carbon atoms; and
(b) a glycol component comprising:
   i) 90 to 100 mole % of 1,4-cyclohexanedimethanol residues, and
   ii) 0 to 10 mole % of modifying glycol residues; and
having an inherent viscosity of about 0.5 to about 1.2 dL/g as determined in 60/40 (wt/wt) phenol/tetrachloroethane at a concentration of 0.5 g/100 ml at 25° C.

In another embodiment, polymeric component (B) comprises a copolyester that comprises:
a polyester segment and a polyether segment, wherein:
the polyester segment comprises residues of an aliphatic diol and either an aliphatic dicarboxylic acid or an ester of an aliphatic dicarboxylic acid, and
the polyether segment comprises a polyalkylene glycol; and
wherein the copolyester ether has an inherent viscosity of about 0.6 to about 1.5 dL/g as determined in 60/40 (wt/wt) phenol/tetrachloroethane at a concentration of 0.5 g/100 ml at 25° C.

In embodiments, the polymeric component (B) comprises a copolyester that comprises a dicarboxylic acid component comprising residues of 1,4-cyclohexane dicarboxylate and a diol component comprising residues of 1,4-cyclohexanedimethanol and poly(tetramethylene ether)glycol.

In one embodiment, the polymeric component (B) comprises a copolyester that comprises:
(a) a dicarboxylic acid component comprising:
   i) 90 to100 mole % of 1,4-cyclohexane dicarboxylic acid residues;
   ii) 0 to 10 mole % of aromatic and/or aliphatic dicarboxylic acid residues having up to 20 carbon atoms; and
(b) a glycol component comprising:
   i) 95 to 80 mole % of 1,4-cyclohexanedimethanol residues, and
   ii) 5 to 20 mole % of poly(tetramethylene ether)glycol residues; and
has an inherent viscosity of about 0.9 to about 1.4 dL/g as determined in 60/40 (wt/wt) phenol/tetrachloroethane at a concentration of 0.5 g/100 ml at 25° C. In another embodiment, the inherent viscosity ranges from about 1.02 to about 1.26.

In another embodiment, the multicomponent composition comprises three polymer components (A), (B) and (C) where the polymer components are different. In embodiments for the three-component composition, polymeric component (A) is present in an amount from greater than 50 to 99 wt % and polymeric components (B) and (C) are each present in an amount from 1 to less than 50 wt %. In embodiments for the three-component composition, the polymeric component (A) can be a polyester as described above for component (A) in embodiments for the (at least) two component composition and components (B) and (C) can independently be a polyester or copolyester as described above for component (B) in the embodiments for the (at least) two component composition, with the proviso that components (B) and (C) are different.

In embodiments for the three-component composition, polymeric component (A) comprises a polyester that comprises:
(a) a dicarboxylic acid component comprising:
   i) 70 to 100 mole % of terephthalic acid residues; and
   ii) 0 to 30 mole % of aromatic and/or aliphatic dicarboxylic acid residues having up to 20 carbon atoms; and
(b) a glycol component comprising:
   i) 10 to 50 mole % of 2,2,4,4-tetramethyl-1,3-cyclobutanediol residues;
   ii) 0 to 90 mole % of 1,4-cyclohexanedimethanol residues; and
   iii) 0 to 90 mole % of ethylene glycol residues; and
having an inherent viscosity of about 0.4 to about 0.9 dL/g as determined in 60/40 (wt/wt) phenol/tetrachloroethane at a concentration of 0.5 g/100 ml at 25° C.; and
polymeric components (B) and (C) each comprise a polyester which is other than the polyester in polymeric component (A), with the proviso that components (B) and (C) are different from each other.

In embodiments for the three-component composition, polymeric component (B) comprises a polyester that comprises:
(a) a dicarboxylic acid component comprising:
   i) 90 to 100 mole % of 1,4-cyclohexane dicarboxylic acid residues;
   ii) 0 to 10 mole % of aromatic and/or aliphatic dicarboxylic acid residues having up to 20 carbon atoms; and
(b) a glycol component comprising:
   i) 90 to 100 mole % of 1,4-cyclohexanedimethanol residues, and
   ii) 0 to 10 mole % of modifying glycol residues; and
having an inherent viscosity of about 0.5 to about 1.2 dL/g as determined in 60/40 (wt/wt) phenol/tetrachloroethane at a concentration of 0.5 g/100 ml at 25° C.

In embodiments for the three-component composition, the polymeric component (C) comprises a copolyester that comprises:
(a) a dicarboxylic acid component comprising:
   i) 90 to100 mole % of 1,4-cyclohexane dicarboxylic acid residues;
   ii) 0 to 10 mole % of aromatic and/or aliphatic dicarboxylic acid residues having up to 20 carbon atoms; and
(b) a glycol component comprising:
   i) 95 to 80 mole % of 1,4-cyclohexanedimethanol residues, and
   ii) 5 to 20 mole % of poly(tetramethylene ether)glycol residues; and
has an inherent viscosity of about 0.9 to about 1.4 dL/g as determined in 60/40 (wt/wt) phenol/tetrachloroethane at a concentration of 0.5 g/100 ml at 25° C. In another embodiment, the inherent viscosity ranges from about 1.02 to about 1.26.

In other embodiments (for any of the embodiments described herein in this application), the polymeric component (A) is a polyester that comprises:
(a) a dicarboxylic acid component comprising:
   i) 70 to 100 mole % of terephthalic acid residues; and
   ii) 0 to 30 mole % of aromatic and/or aliphatic dicarboxylic acid residues having up to 20 carbon atoms; and
(b) a glycol component comprising:
   i) 10 to 40 mole % of isosorbide residues;
   ii) 0 to 90 mole % of 1,4-cyclohexanedimethanol residues; and
   iii) 0 to 90 mole % of ethylene glycol residues; and
having an inherent viscosity of about 0.4 to about 1.2 dL/g as determined in 60/40 (wt/wt) phenol/tetrachloroethane at a concentration of 0.5 g/100 ml at 25° C.

In further embodiments (for any of the embodiments described herein in this application), the polymeric component (A) is a polyester that comprises:
(a) a dicarboxylic acid component comprising:
   i) 90 to 100 mole % of terephthalic acid residues;
   ii) 0 to 10 mole % of aromatic and/or aliphatic dicarboxylic acid residues having up to 20 carbon atoms; and
(b) a glycol component comprising:
   i) 10 to 40 mole % of 2,2,4,4-tetramethyl-1,3-cyclobutanediol residues;
   ii) 60 to 90 mole % of 1,4-cyclohexanedimethanol residues; and
has an inherent viscosity of about 0.5 to about 0.9 dL/g as determined in 60/40 (wt/wt) phenol/tetrachloroethane at a concentration of 0.5 g/100 ml at 25° C. In another embodiment, the inherent viscosity of polymeric component (A) is between about 0.6 and 0.8 dL/g.

In further embodiments (for any of the embodiments described herein in this application), the polymeric component (A) is a polyester that comprises:
(a) a dicarboxylic acid component comprising:
   i) 90 to 100 mole % of terephthalic acid residues;
   ii) 0 to 10 mole % of aromatic and/or aliphatic dicarboxylic acid residues having up to 20 carbon atoms; and
(b) a glycol component comprising:
   i) 10 to 40 mole % of 2,2,4,4-tetramethyl-1,3-cyclobutanediol residues;
   ii) 60 to 90 mole % of ethylene glycol residues; and
has an inherent viscosity of about 0.4 to about 0.9 dL/g as determined in 60/40 (wt/wt) phenol/tetrachloroethane at a concentration of 0.5 g/100 ml at 25° C. In another embodiment, the inherent viscosity of said polymeric component (A) is between about 0.5 and 0.7 dL/g.

In further embodiments (for any of the embodiments described herein in this application), the polymeric component (B) or (C) as applicable is a copolyester that comprises:
(a) a dicarboxylic acid component comprising:
   i) 90 to100 mole % of 1,4-cyclohexane dicarboxylic acid residues;
   ii) 0 to 10 mole % of aromatic and/or aliphatic dicarboxylic acid residues having up to 20 carbon atoms; and
(b) a glycol component comprising:
   i) 15 to 65 mole % of 1,4-cyclohexanedimethanol residues, and
   ii) 85 to 35 mole % ethylene glycol residues;
and has an inherent viscosity of about 0.4 to about 0.8 dL/g as determined in 60/40 (wt/wt) phenol/tetrachloroethane at a concentration of 0.5 g/100 ml at 25° C. In this embodiment, the total moles of the glycol component add up to 100 mole % and may further be comprised of 0 to 15 mole % of residues of diethylene glycol. In embodiments, the 1,4-cyclohexane dicarboxylic acid residues can comprise the trans-1,4-cyclohexane dicarboxylic acid isomer in an amount greater than 50 mole %, or greater than 75 mole %, or greater than 90 mole %, based on the total amount of 1,4-cyclohexane dicarboxylic acid residues present in the polyester.

Examples of materials that can be used for polymeric component (A) can include Tritan™ MP100, TX1000, TX1500, TX2000, TX1800, MX710, MX711, MX810, and MX730 copolyesters, available from Eastman Chemical Company. Examples of materials that can be used for polymeric components (B) or (C) can include Neostar 19972 copolyester, or Ecdel™ Elastomer 9966 or 9967, available from Eastman Chemical Company.

The term “polyester”, as used herein, unless otherwise specifically indicated is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds. Typically, the difunctional carboxylic acid can be a dicarboxylic acid and the difunctional hydroxyl compound can be a dihydric alcohol such as, for example, glycols. The term “glycol” as used herein includes, but is not limited to, diols, glycols, and/or multifunctional hydroxyl compounds. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, or mixtures thereof or residues thereof useful in a reaction process with a diol to make polyester.

In one embodiment, terephthalic acid may be used as the starting material. In another embodiment, dimethyl terephthalate may be used as the starting material. In another embodiment, mixtures of terephthalic acid and dimethyl terephthalate may be used as the starting material and/or as an intermediate material.

The polyesters used in the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compounds) residues (100 mole %) such that the total moles of repeating units is equal to 100 mole %. The mole percentages provided herein, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 30 mole % 2,2,4,4-tetramethyl-1,3-cyclobutanediol, based on the total diol residues, means the polyester contains 30 mole % 2,2,4,4-tetramethyl-1,3-cyclobutanediol residues out of a total of 100 mole % diol residues. Thus, there are 30 moles of 2,2,4,4-tetramethyl-1,3-cyclobutanediol residues among every 100 moles of diol residues.

For the desired polyester, the molar ratio of cis/trans 2,2,4,4-tetramethyl-1,3-cyclobutanediol can vary from the pure form of each or mixtures thereof. In certain embodiments, the molar percentages for cis and/or trans 2,2,4,4,-tetramethyl-1,3-cyclobutanediol are greater than 50 mole % cis and less than 50 mole % trans; or greater than 55 mole % cis and less than 45 mole % trans; or 30 to 70 mole % cis and 70 to 30% trans; or 40 to 60 mole % cis and 60 to 40 mole % trans; or 50 to 70 mole % trans and 50 to 30% cis or 50 to 70 mole % cis and 50 to 30% trans; or 60 to 70 mole % cis and 30 to 40 mole % trans; or greater than 70 mole cis and less than 30 mole % trans; wherein the total sum of the mole percentages for cis- and trans-2,2,4,4-tetramethyl-1,3-cyclobutanediol is equal to 100 mole %. The molar ratio of cis/trans 1,4-cyclohexanedimethanol can vary within the range of 50/50 to 0/100, such as between 40/60 to 20/80.

In certain embodiments for the polymeric component (A) polyester, terephthalic acid or an ester thereof, such as, for example, dimethyl terephthalate, or a mixture of terephthalic acid and an ester thereof, makes up most or all of the dicarboxylic acid component used to form the polyesters useful in the invention. In certain embodiments, terephthalic acid residues can make up a portion or all of the dicarboxylic acid component used to form the polyester at a concentration of at least 70 mole %, such as at least 80 mole %, at least 90 mole %, at least 95 mole %, at least 99 mole %, or 100 mole %. In certain embodiments, higher amounts of terephthalic acid can be used in order to produce a higher impact strength polyester. In one embodiment, dimethyl terephthalate is part, or all of the dicarboxylic acid component used to make the polyesters useful in the present invention. As used herein, the terms “terephthalic acid” and “dimethyl terephthalate” are used interchangeably, unless specifically indicated otherwise.

In addition to terephthalic acid, the dicarboxylic acid component of the copolyester useful in polymeric component (A) can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, from 0.01 to 30 mole %, 0.01 to 20 mole %, from 0.01 to 10 mole %, from 0.01 to 5 mole % and from 0.01 to 1 mole. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the polyesters useful for polymeric component (A) can be further modified with up to 10 mole %, such as up to 5 mole % or up to 1 mole % of one or more aliphatic dicarboxylic acids containing up to 20 carbon atoms, such as, for example, malonic, succinic, glutaric, adipic, pimelic, suberic, azelaic and dodecanedioic dicarboxylic acids. Certain embodiments can also comprise 0.01 or more mole %, such as 0.1 or more mole %, 1 or more mole %, 5 or more mole %, or 10 or more mole % of one or more modifying aliphatic dicarboxylic acids. Yet another embodiment contains 0 mole % modifying aliphatic dicarboxylic acids. Thus, if present, it is contemplated that the amount of one or more modifying aliphatic dicarboxylic acids can range from any of these preceding endpoint values including, for example, from 0.01 to 10 mole % and from 0.1 to 10 mole %. The total mole % of the dicarboxylic acid component is 100 mole %.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

The 1,4-cyclohexanedimethanol may be cis, trans, or a mixture thereof, for example a cis/trans ratio of 60:40 to 40:60. In another embodiment, the trans-1,4-cyclohexanedimethanol can be present in an amount of 60 to 80 mole %.

In embodiments, the glycol component of the polyesters of polymeric component (A) described above can contain up to 35 mole % of one or more modifying glycols which are not 2,2,4,4-tetramethyl-1,3-cyclobutanediol or 1,4-cyclohexanedimethanol.

Modifying glycols useful in the polyesters can be diols other than 2,2,4,4,-tetramethyl-1,3-cyclobutanediol and 1,4-cyclohexanedimethanol and may contain 2 to 16 carbon atoms. Examples of suitable modifying glycols include, but are not limited to, ethylene glycol, 1,2-propanediol, 1,3-propanediol, neopentyl glycol, 1,4-butanediol, 1,5-pentanediol, 1,6-hexanediol, p-xylene glycol, isosorbide or mixtures thereof. In one embodiment, the modifying glycol is ethylene glycol. In another embodiment, the modifying glycols are 1,3-propanediol and/or 1,4-butanediol. In another embodiment, ethylene glycol is excluded as a modifying diol. In another embodiment, 1,3-propanediol and 1,4-butanediol are excluded as modifying diols. In another embodiment, 2,2-dimethyl-1,3-propanediol is excluded as a modifying diol.

In embodiments, the polyesters as described herein (in embodiments for polymeric component (A)) can further comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues; respectively, of one or more residues of a branching monomer or agent, also referred to herein as a branching agent, having 3 or more carboxyl substituents, hydroxyl substituents, or a combination thereof. In embodiments, the polyesters described herein (in embodiments for polymeric components (B) and/or (C)) can also include branching agents in an amount from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues.

In certain embodiments, the branching monomer or agent may be added prior to and/or during and/or after the polymerization of the polyester. The polyester(s) useful in the invention can thus be linear or branched.

Examples of branching monomers or agents can include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer or agent may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

In certain embodiments, the Tg of the TMCD containing polyesters useful for polymeric component (A) can be from about 70 to 150° C., or 90 to 130° C., or 100 to 120° C. In certain embodiments, the Tg of the 1,4-cyclohexane dicarboxylate containing polyesters useful for polymeric component (B) can be from about 30 to 110° C., or 50 to 90° C., or 60 to 80° C. In certain embodiments, the Tg of the polyesters containing a polyether segment useful for polymeric component (B) or (C) can be from about −80 to 50° C., or −60 to 20° C., or −50 to −20° C. The glass transition temperature (Tg) of the polyesters can be determined using a TA DSC 2920 from Thermal Analyst Instrument at a scan rate of 20° C./min.

In addition, the multicomponent compositions useful in this invention may also contain from 0.01 to 25% by weight or 0.01 to 20% by weight or 0.01 to 15% by weight or 0.01 to 10% by weight or 0.01 to 5% by weight of the total weight of the polyester composition of common additives such as colorants, dyes, slip or release agents, and/or stabilizers, including but not limited to thermal or hydrolytic stabilizers.

In certain embodiments, where the polymeric component (A) comprises copolyesters containing TMCD and CHDM residues, the glycol component for the polyesters can include but is not limited to at least one of the following combinations of ranges: 10 to 40 mole % 2,2,4,4-tetramethyl-1,3-cyclobutanediol and 60 to 90 mole % 1,4-cyclohexanedimethanol; 10 to 35 mole % 2,2,4,4-tetramethyl-1,3-cyclobutanediol and 65 to 90 mole % 1,4-cyclohexanedimethanol; 10 to less than 35 mole % 2,2,4,4-tetramethyl-1,3-cyclobutanediol and greater than 65 up to 90 mole % 1,4-cyclohexanedimethanol; 10 to 30 mole % 2,2,4,4-tetramethyl-1,3-cyclobutanediol and 70 to 90 mole % 1,4-cyclohexanedimethanol; 10 to 25 mole % 2,2,4,4-tetramethyl-1,3-cyclobutanediol and greater than 75 to 90 mole % 1,4-cyclohexanedimethanol; 11 to 25 mole % 2,2,4,4-tetramethyl-1,3-cyclobutanediol and 75 to 89 mole % 1,4-cyclohexanedimethanol; 12 to 25 mole % 2,2,4,4-tetramethyl-1,3-cyclobutanediol and 75 to 88 mole % 1,4-cyclohexanedimethanol; and 13 to 25 mole % 2,2,4,4-tetramethyl-1,3-cyclobutanediol and 75 to 87 mole % 1,4-cyclohexanedimethanol.

In other embodiments, the glycol component for the polyesters can include but is not limited to at least one of the following combinations of ranges: 15 to 40 mole % 2,2,4,4-tetramethyl-1,3-cyclobutanediol and 60 to 85 mole % 1,4-cyclohexanedimethanol; 15 to 35 mole % 2,2,4,4-tetramethyl-1,3-cyclobutanediol and 65 to 85 mole % 1,4-cyclohexanedimethanol; 15 to 30 mole % 2,2,4,4-tetramethyl-1,3-cyclobutanediol and 70 to 85 mole % 1,4-cyclohexanedimethanol; 15 to 25 mole % 2,2,4,4-tetramethyl-1,3-cyclobutanediol and 75 to 85 mole % 1,4-cyclohexanedimethanol; 15 to 20 mole % 2,2,4,4-tetramethyl-1,3-cyclobutanediol and 75 to 80 mole % 1,4-cyclohexanedimethanol; and 17 to 23 mole % 2,2,4,4-tetramethyl-1,3-cyclobutanediol and 77 to 83 mole % 1,4-cyclohexanedimethanol.

In other embodiments, where the polymeric component (A) comprises copolyesters containing TMCD and CHDM residues, the glycol component for the polyesters can include but is not limited to at least one of the following combinations of ranges: 20 to 40 mole % 2,2,4,4-tetramethyl-1,3-cyclobutanediol and 60 to 80 mole % 1,4-cyclohexanedimethanol; 20 to 35 mole % 2,2,4,4-tetramethyl-1,3-cyclobutanediol and 65 to 80 mole % 1,4-cyclohexanedimethanol; 20 to 30 mole % 2,2,4,4-tetramethyl-1,3-cyclobutanediol and 70 to 80 mole % 1,4-cyclohexandimethanol; and 20 to 25 mole % 2,2,4,4-tetramethyl-1,3-cyclobutanediol and 75 to 80 mole % 1,4-cyclohexanedimethanol.

In other embodiments, where the polymeric component (A) comprises copolyesters containing TMCD and CHDM residues, the glycol component for the polyesters can include but is not limited to at least one of the following combinations of ranges: 25 to 40 mole % 2,2,4,4-tetramethyl-1,3-cyclobutanediol and 60 to 75 mole % 1,4-cyclohexanedimethanol; 25 to 35 mole % 2,2,4,4-tetramethyl-1,3-cyclobutanediol and 65 to 75 mole % 1,4-cyclohexanedimethanol; and 25 to 30 mole % 2,2,4,4-tetramethyl-1,3-cyclobutanediol and 70 to 75 mole % 1,4-cyclohexanedimethanol; 30 to 40 mole % 2,2,4,4-tetramethyl-1,3-cyclobutanediol and 60 to 70 mole % 1,4-cyclohexanedimethanol; 30 to 35 mole % 2,2,4,4-tetramethyl-1,3-cyclobutanediol and 65 to 70 mole % 1,4-cyclohexanedimethanol.

In certain embodiments, where the polymeric component (A) comprises copolyesters containing TMCD and CHDM residues, the copolyesters can contain less than 15 mole % ethylene glycol residues, such as, for example, 0.01 to less than 15 mole % ethylene glycol residues. In embodiments, the polyesters useful in the invention contain less than 10 mole %, or less than 5 mole %, or less than 4 mole %, or less than 2 mole %, or less than 1 mole % ethylene glycol residues, such as, for example, 0.01 to less than 10 mole %, or 0.01 to less than 5 mole %, or 0.01 to less than 4 mole %, or 0.01 to less than 2 mole %, or 0.01 to less than 1 mole %, ethylene glycol residues. In one embodiment, the copolyesters useful in the invention contain no ethylene glycol residues.

In certain embodiments, where the polymeric component (A) comprises copolyesters containing isosorbide and CHDM residues, the glycol component for the polyesters can include but is not limited to at least one of the following combinations of ranges: 10 to 40 mole % isosorbide, 20 to 80 mole % 1,4-cyclohexanedimethanol, and 10 to 40 mole % EG; 10 to 35 mole % isosorbide, 25 to 80 mole % 1,4-cyclohexanedimethanol, and 10 to 40 mole % EG; 10 to less than 35 mole % isosorbide, greater than 25 up to 80 mole % 1,4-cyclohexanedimethanol, and 10 to 40 mole % EG; 10 to 30 mole % isosorbide, 30 to 80 mole % 1,4-cyclohexanedimethanol, and 10 to 40 mole % EG; 10 to 25 mole % isosorbide, 35 to 80 mole % 1,4-cyclohexanedimethanol, and 10 to 40 mole % EG; 11 to 25 mole % isosorbide, 35 to 79 mole % 1,4-cyclohexanedimethanol, and 10 to 40 mole % EG; 12 to 25 mole % isosorbide, 35 to 78 mole % 1,4-cyclohexanedimethanol, and 10 to 40 mole % EG; and 13 to 25 mole % isosorbide, 35 to 77 mole % 1,4-cyclohexanedimethanol, and 10 to 40 mole % EG.

In other embodiments, the glycol component for the polyesters can include but is not limited to at least one of the following combinations of ranges: 15 to 40 mole % isosorbide, 20 to 75 mole % 1,4-cyclohexanedimethanol, and 10 to 40 mole % EG; 15 to 35 mole % isosorbide, 25 to 75 mole % 1,4-cyclohexanedimethanol, and 10 to 40 mole % EG; 15 to 30 mole % isosorbide, 30 to 75 mole % 1,4-cyclohexanedimethanol, and 10 to 40 mole % EG; 15 to 25 mole % isosorbide, 35 to 75 mole % 1,4-cyclohexanedimethanol, and 10 to 40 mole % EG; 15 to 20 mole % isosorbide, 40 to 75 mole % 1,4-cyclohexanedimethanol, and 10 to 40 mole % EG; 17 to 23 mole % isosorbide, 37 to 73 mole % 1,4-cyclohexanedimethanol, and 10 to 40 mole % EG; 15 to 30 mole % isosorbide, 40 to 75 mole % 1,4-cyclohexanedimethanol, and 10 to 30 mole % EG; 20 to 30 mole % isosorbide, 40 to 65 mole % 1,4-cyclohexanedimethanol, and 15 to 30 mole % EG.

In other embodiments, the glycol component for the polyesters can include but is not limited to at least one of the following combinations of ranges: 10 to 30 mole % isosorbide, 40 to 75 mole % 1,4-cyclohexanedimethanol, and 30 to 45 mole % EG; 20 to 30 mole % isosorbide, 40 to 65 mole % 1,4-cyclohexanedimethanol, and 20 to 30 mole % EG; 20 to 35 mole % isosorbide, 40 to 55 mole % 1,4-cyclohexanedimethanol, and 20 to 30 mole % EG.

In embodiments, where the polymeric component (A) comprises copolyesters containing TMCD and EG residues, the polyesters can include a copolyester comprising: (a) diacid residues comprising from about 90 to 100 mole percent of TPA residues and from 0 to about 10 mole percent IPA residues; and (b) diol residues comprising at least 60 mole percent of EG residues and up to 40 mole percent of TMCD residues, wherein the copolyester comprises a total of 100 mole percent diacid residues and a total of 100 mole percent diol residues.

In embodiments, the copolyester comprises diol residues comprising from 10 to 40 mole percent TMCD residues and 60 to 90 mole percent EG residues. In embodiments, the copolyester comprises diol residues comprising 20 to 37 mole percent TMCD residues and 63 to 80 mole percent EG residues. In one embodiment, the copolyester comprises diol residues comprising 22 to 35 mole percent TMCD residues and 65 to 78 mole percent EG residues.

In certain embodiments, where the polymeric component (A) comprises copolyesters containing TMCD and EG residues, the copolyester comprises: a) a dicarboxylic acid component comprising: (i) 90 to 100 mole % terephthalic acid residues; and (ii) about 0 to about 10 mole % of aromatic and/or aliphatic dicarboxylic acid residues having up to 20 carbon atoms; and (b) a glycol component comprising: (i) about 10 to about 27 mole % 2,2,4,4-tetramethyl-1,3-cyclobutanediol (TMCD) residues; and (ii) about 90 to about 73 mole % ethylene glycol residues; and wherein the total mole % of the dicarboxylic acid component is 100 mole %, and wherein the total mole % of the glycol component is 100 mole %; and wherein the inherent viscosity (IV) of the polyester is from 0.50 to 0.8 dL/g as determined in 60/40 (wt/wt) phenol/tetrachloroethane at a concentration of 0.25 g/50 ml at 25° C.; and wherein the L* color values for the polyester is 90 or greater, as determined by the L*a*b* color system measured following ASTM D 6290-98 and ASTM E308-99, performed on polymer granules ground to pass a 1 mm sieve. In embodiments, the L* color values for the polyester is greater than 90, as determined by the L*a*b* color system measured following ASTM D 6290-98 and ASTM E308-99, performed on polymer granules ground to pass a 1 mm sieve.

In certain embodiments, the glycol component of the copolyester comprises: (i) about 15 to about 25 mole % 2,2,4,4-tetramethyl-1,3-cyclobutanediol (TMCD) residues; and (ii) about 85 to about 75 mole % ethylene glycol residues; or (i) about 20 to about 25 mole % 2,2,4,4-tetramethyl-1,3-cyclobutanediol (TMCD) residues; and (ii) about 80 to about 75 mole % ethylene glycol residues; or (i) about 21 to about 24 mole % 2,2,4,4-tetramethyl-1,3-cyclobutanediol (TMCD) residues; and (ii) about 86 to about 79 mole % ethylene glycol residues.

In embodiments, where the polymeric component (A) comprises copolyesters containing TMCD and EG residues, the copolyester has at least one of the following properties chosen from: a Tg of from about 90 to about 110° C. as measured by a TA 2100 Thermal Analyst Instrument at a scan rate of 20° C./min, a flexural modulus at 23° C. of greater than about 2000 MPa (290,000 psi) as defined by ASTM D790, and a notched Izod impact strength greater than about 25 J/m (0.47 ft-lb/in) according to ASTM D256 with a 10-mil notch using a 1/8-inch thick bar at 23° C. In one embodiment, the L* color values for the copolyester is 90 or greater, or greater than 90, as determined by the L*a*b* color system measured following ASTM D 6290-98 and ASTM E308-99, performed on polymer granules ground to pass a 1 mm sieve.

In one embodiment, where the polymeric component (A) comprises copolyesters containing TMCD and EG residues, the copolyester further comprises: (II) a catalyst/stabilizer component comprising: (i) titanium atoms in the range of 10-50 ppm based on polymer weight, (ii) optionally, manganese atoms in the range of 10-100 ppm based on polymer weight, and (iii) phosphorus atoms in the range of 10-200 ppm based on polymer weight. In one embodiment, the 2,2,4,4-tetramethyl-1,3-cyclobutanediol residues is a mixture comprising more than 50 mole % of cis-2,2,4,4-tetramethyl-1,3-cyclobutanediol residues and less than 50 mole % of trans-2,2,4,4-tetramethyl-1,3-cyclobutanediol residues.

In certain embodiments, where the polymeric component (A) comprises copolyesters containing TMCD and EG residues, the glycol component for the copolyesters can include but are not limited to at least one of the following combinations of ranges: about 10 to about 30 mole % 2,2,4,4-tetramethyl-1,3-cyclobutanediol and about 90 to about 70 mole % ethylene glycol; about 10 to about 27 mole % 2,2,4,4-tetramethyl-1,3-cyclobutanediol and about 90 to about 73 mole % ethylene glycol; about 15 to about 26 mole % 2,2,4,4-tetramethyl-1,3-cyclobutanediol and about 85 to about 74 mole % ethylene glycol; about 18 to about 26 mole % 2,2,4,4-tetramethyl-1,3-cyclobutanediol and about 82 to about 77 mole % ethylene glycol; about 20 to about 25 mole % 2,2,4,4-tetramethyl-1,3-cyclobutanediol and about 80 to about 75 mole % ethylene glycol; about 21 to about 24 mole % 2,2,4,4-tetramethyl-1,3-cyclobutanediol and about 79 to about 76 mole % ethylene glycol; or about 22 to about 24 mole % 2,2,4,4-tetramethyl-1,3-cyclobutanediol and about 78 to about 76 mole % ethylene glycol.

In certain embodiments, where the polymeric component (A) comprises copolyesters containing TMCD and EG residues, the copolyesters may exhibit at least one of the following inherent viscosities as determined in 60/40 (wt/wt) phenol/tetrachloroethane at a concentration of 0.25 g/50 ml at 25° C. from 0.50 to 0.8 dL/g; 0.55 to 0.75 dL/g; 0.57 to 0.73 dL/g; 0.58 to 0.72 dL/g; 0.59 to 0.71 dL/g; 0.60 to 0.70 dL/g; 0.61 to 0.69 dL/g; 0.62 to 0.68 dL/g; 0.63 to 0.67 dL/g; 0.64 to 0.66 dL/g; or about 0.65 dL/g.

In certain embodiments, where the polymeric component (A) comprises copolyesters containing TMCD and EG residues, the Tg of the copolyester can be chosen from one of the following ranges: 85 to 100° C.; 86 to 99° C.; 87 to 98° C.; 88 to 97° C.; 89 to 96° C.; 90 to 95° C.; 91 to 95° C.; 92 to 94° C.

In other embodiments, where the polymeric component (A) comprises copolyesters containing TMCD and EG residues, the copolyester comprises diol residues comprising 30 to 42 mole percent TMCD residues and 58 to 70 mole percent EG residues. In one embodiment, the copolyester comprises diol residues comprising 33 to 38 mole percent TMCD residues and 62 to 67 mole percent EG residues.

In certain embodiments, where the polymeric component (A) comprises copolyesters containing TMCD and EG residues, the copolyester comprises: a) a dicarboxylic acid component comprising: (i) 90 to 100 mole % terephthalic acid residues; and (ii) about 0 to about 10 mole % of aromatic and/or aliphatic dicarboxylic acid residues having up to 20 carbon atoms; and (b) a glycol component comprising: (i) about 30 to about 40 mole % 2,2,4,4-tetramethyl-1,3-cyclobutanediol (TMCD) residues; and (ii) about 70 to about 60 mole % ethylene glycol residues; and wherein the total mole % of the dicarboxylic acid component is 100 mole %, and wherein the total mole % of the glycol component is 100 mole %; and wherein the inherent viscosity (IV) of the polyester is from 0.50 to 0.70 dL/g as determined in 60/40 (wt/wt) phenol/tetrachloroethane at a concentration of 0.25 g/50 ml at 25° C.; and wherein the L* color values for the polyester is 90 or greater, as determined by the L*a*b* color system measured following ASTM D 6290-98 and ASTM E308-99, performed on polymer granules ground to pass a 1 mm sieve. In embodiments, the L* color values for the polyester is greater than 90, as determined by the L*a*b* color system measured following ASTM D 6290-98 and ASTM E308-99, performed on polymer granules ground to pass a 1 mm sieve.

In certain embodiments, where the polymeric component (A) comprises copolyesters containing TMCD and EG residues, the glycol component comprises: (i) about 32 to about 40 mole % 2,2,4,4-tetramethyl-1,3-cyclobutanediol (TMCD) residues, and (ii) about 68 to about 60 mole % ethylene glycol residues; or (i) about 34 to about 40 mole % 2,2,4,4-tetramethyl-1,3-cyclobutanediol (TMCD) residues, and (ii) about 66 to about 60 mole % ethylene glycol residues; or (i) greater than 34 to about 40 mole % 2,2,4,4-tetramethyl-1,3-cyclobutanediol (TMCD) residues, and (ii) less than 66 to about 60 mole % ethylene glycol residues; or (i) 34.2 to about 40 mole % 2,2,4,4-tetramethyl-1,3-cyclobutanediol (TMCD) residues, and (ii) 65.8 to about 60 mole % ethylene glycol residues; or (i) about 35 to about 39 mole % 2,2,4,4-tetramethyl-1,3-cyclobutanediol (TMCD) residues, and (ii) about 65 to about 61 mole % ethylene glycol residues; or (i) about 36 to about 37 mole % 2,2,4,4-tetramethyl-1,3-cyclobutanediol (TMCD) residues; and (ii) about 64 to about 63 mole % ethylene glycol residues.

In certain embodiments, where the polymeric component (A) comprises copolyesters containing TMCD and EG residues, the copolyester has at least one of the following properties chosen from: a Tg of from about 100 to about 110° C. as measured by a TA 2100 Thermal Analyst Instrument at a scan rate of 20° C./min, a flexural modulus at 23° C. of equal to or greater than 2000 MPa (290,000 psi), or greater than 2200 MPa (319,000 psi) as defined by ASTM D790, a notched Izod impact strength of about 30 J/m (0.56 ft-lb/in) to about 80 J/m (1.50 ft-lb/in) according to ASTM D256 with a 10-mil notch using a 1/8-inch thick bar at 23° C., and less than 5% loss in inherent viscosity after being held at a temperature of 293° C. (560° F.) for 2 minutes. In one embodiment, the L* color values for the polyester composition is 90 or greater, or greater than 90, as determined by the L*a*b* color system measured following ASTM D 6290-98 and ASTM E308-99, performed on polymer granules ground to pass a 1 mm sieve.

In one embodiment, where the polymeric component (A) comprises copolyesters containing TMCD and EG residues, the copolyester comprises a diol component having at least 30 mole percent TMCD residues (based on the diols) and a catalyst/stabilizer component comprising: (i) titanium atoms in the range of 10-60 ppm based on polymer weight, (ii) manganese atoms in the range of 10-100 ppm based on polymer weight, and (iii) phosphorus atoms in the range of 10-200 ppm based on polymer weight. In one embodiment, the 2,2,4,4-tetramethyl-1,3-cyclobutanediol residues is a mixture comprising more than 50 mole % of cis-2,2,4,4-tetramethyl-1,3-cyclobutanediol residues and less than 50 mole % of trans-2,2,4,4-tetramethyl-1,3-cyclobutanediol residues.

In certain embodiments, the glycol component for the copolyesters includes but is not limited to at least one of the following combinations of ranges: about 30 to about 40 mole % 2,2,4,4-tetramethyl-1,3-cyclobutanediol and about 60 to 70 mole % ethylene glycol; about 32 to about 40 mole % 2,2,4,4-tetramethyl-1,3-cyclobutanediol and about 60 to 68 mole % ethylene glycol; about 32 to about 38 mole % 2,2,4,4-tetramethyl-1,3-cyclobutanediol and about 64 to 68 mole % ethylene glycol; about 33 to about 40 mole % 2,2,4,4-tetramethyl-1,3-cyclobutanediol and about 60 to 67 mole % ethylene glycol; about 34 to about 40 mole % 2,2,4,4-tetramethyl-1,3-cyclobutanediol and about 60 to 66 mole % ethylene glycol; greater than 34 to about 40 mole % 2,2,4,4-tetramethyl-1,3-cyclobutanediol and 60 to less than 66 mole % ethylene glycol; 34.2 to 40 mole % 2,2,4,4-tetramethyl-1,3-cyclobutanediol and about 60 to 65.8 mole % ethylene glycol; about 35 to about 39 mole % 2,2,4,4-tetramethyl-1,3-cyclobutanediol and about 61 to 65 mole % ethylene glycol; about 35 to about 38 mole % 2,2,4,4-tetramethyl-1,3-cyclobutanediol and about 62 to 65 mole % ethylene glycol; or about 36 to about 37 mole % 2,2,4,4-tetramethyl-1,3-cyclobutanediol and about 63 to 64 mole % ethylene glycol.

In certain embodiments, where the polymeric component (A) comprises copolyesters containing TMCD and EG residues, the polyesters may exhibit at least one of the following inherent viscosities as determined in 60/40 (wt/wt) phenol/tetrachloroethane at a concentration of 0.25 g/50 ml at 25° C. from 0.50 to 0.70 dL/g; 0.55 to 0.65 dL/g; 0.56 to 0.64 dL/g; 0.56 to 0.63 dL/g; 0.56 to 0.62 dL/g; 0.56 to 0.61 dL/g; 0.57 to 0.64 dL/g; 0.58 to 0.64 dL/g; 0.57 to 0.63 dL/g; 0.57 to 0.62 dL/g; 0.57 to 0.61 dL/g; 0.58 to 0.60 dL/g or about 0.59 dL/g.

In certain of the embodiments, where the polymeric component (A) comprises copolyesters containing TMCD and EG residues, such copolyesters can contain less than 10 mole %, or less than 5 mole %, or less than 4 mole %, or less than 3 mole %, or less than 2 mole %, or less than 1 mole %, or no, CHDM residues.

In embodiments, the polyesters described herein for embodiments for polymeric component (A) may exhibit at least one of the following inherent viscosities as determined in 60/40 (wt/wt) phenol/tetrachloroethane at a concentration of 0.5 g/100 ml at 25° C.: 0.10 to 1.2 dL/g; 0.10 to 1.1 dL/g; 0.10 to 1 dL/g; 0.10 to less than 1 dL/g; 0.10 to 0.98 dL/g; 0.10 to 0.95 dl/g; 0.10 to 0.90 dL/g; 0.10 to 0.85 dL/g; 0.10 to 0.80 dL/g; 0.10 to 0.75 dL/g; 0.10 to less than 0.75 dL/g; 0.10 to 0.72 dL/g; 0.10 to 0.70 dL/g; 0.10 to less than 0.70 dL/g; 0.10 to 0.68 dL/g; 0.10 to less than 0.68 dL/g; 0.10 to 0.65 dL/g; 0.20 to 1.2 dL/g; 0.20 to 1.1 dL/g; 0.20 to 1 dL/g; 0.20 to less than 1 dL/g; 0.20 to 0.98 dL/g; 0.20 to 0.95 dL/g; 0.20 to 0.90 dL/g; 0.20 to 0.85 dL/g; 0.20 to 0.80 dL/g; 0.20 to 0.75 dL/g; 0.20 to less than 0.75 dL/g; 0.20 to 0.72 dL/g; 0.20 to 0.70 dL/g; 0.20 to less than 0.70 dL/g; 0.20 to 0.68 dL/g; 0.20 to less than 0.68 dL/g; 0.20 to 0.65 dL/g; 0.35 to 1.2 dL/g; 0.35 to 1.1 dL/g; 0.35 to 1 dL/g; 0.35 to less than 1 dL/g; 0.35 to 0.98 dL/g; 0.35 to 0.95 dL/g; 0.35 to 0.90 dL/g; 0.35 to 0.85 dL/g; 0.35 to 0.80 dL/g; 0.35 to 0.75 dL/g; 0.35 to less than 0.75 dL/g; 0.35 to 0.72 dL/g; 0.35 to 0.70 dL/g; 0.35 to less than 0.70 dL/g; 0.35 to 0.68 dL/g; 0.35 to less than 0.68 dL/g; 0.35 to 0.65 dL/g; 0.40 to 1.2 dL/g; 0.40 to 1.1 dL/g; 0.40 to 1 dL/g; 0.40 to less than 1 dL/g; 0.40 to 0.98 dL/g; 0.40 to 0.95 dL/g; 0.40 to 0.90 dL/g; 0.40 to 0.85 dL/g; 0.40 to 0.80 dL/g; 0.40 to 0.75 dL/g; 0.40 to less than 0.75 dl/g; 0.40 to 0.72 dL/g; 0.40 to 0.70 dL/g; 0.40 to less than 0.70 dL/g; 0.40 to 0.68 dL/g; 0.40 to less than 0.68 dL/g; 0.40 to 0.65 dL/g; greater than 0.42 to 1.2 dL/g; greater than 0.42 to 1.1 dL/g; greater than 0.42 to 1 dL/g; greater than 0.42 to less than 1 dL/g; greater than 0.42 to 0.98 dL/g; greater than 0.42 to 0.95 dL/g; greater than 0.42 to 0.90 dL/g; greater than 0.42 to 0.85 dL/g; greater than 0.42 to 0.80 dL/g; greater than 0.42 to 0.75 dL/g; greater than 0.42 to less than 0.75 dL/g; greater than 0.42 to 0.72 dL/g; greater than 0.42 to less than 0.70 dL/g; greater than 0.42 to 0.68 dL/g; greater than 0.42 to less than 0.68 dL/g; and greater than 0.42 to 0.65 dL/g.

For certain embodiments, the polyesters described herein in embodiments for polymeric component (B) or (C) comprising 1,4-cyclohexane dicarboxylate may exhibit at least one of the following inherent viscosities as determined in 60/40 (wt/wt) phenol/tetrachloroethane at a concentration of 0.5 g/100 ml at 25° C.: 0.45 to 1.50 dL/g; 0.45 to 1.40 dL/g; 0.45 to 1.30 dL/g; 0.45 to 1.25 dL/g; 0.45 to 1.20 dL/g; 0.45 to 1.15 dL/g; 0.45 to 1.10 dL/g; 0.45 to 1.05 dL/g; 0.45 to less than 1 dL/g; 0.50 to 1.50 dL/g; 0.50 to 1.40 dL/g; 0.50 to 1.30 dL/g; 0.50 to less than 1.25 dL/g; 0.60 to 1.30 dL/g; 0.60 to 1.20 dL/g; 0.60 to 1.10 dL/g; 0.70 to 1.30 dL/g; 0.70 to 1.20 dL/g; 0.70 to 1.10 dL/g; 0.80 to less than 1.5 dL/g; 0.80 to 1.45 dL/g; 0.80 to 1.40 dL/g; 0.80 to less than 1.40 dL/g; 0.80 to 1.35 dL/g; 0.80 to less than 1.3 dL/g; 0.80 to 1.25 dL/g; 0.80 to 1.20 dL/g; 0.80 to 1.15 dl/g; 0.80 to 1.10 dL/g; 0.80 to less than 1.10 dL/g; 0.80 to 1.05 dL/g; 0.80 to 1.00 dL/g; 0.80 to 0.95 dL/g; 0.80 to 0.90 dL/g; 0.85 to 1.50 dL/g; 0.85 to 1.40 dL/g; 0.85 to less than 1.40 dL/g; 0.85 to 1.35 dL/g; 0.85 to 1.30 dL/g; 0.85 to less than 1.30 dL/g; 0.85 to 1.25 dL/g; 0.85 to less than 1.25 dL/g; 0.85 to 1.20 dL/g; 0.85 to 1.15 dL/g; 0.85 to 1.10 dL/g; 0.85 to 1.05 dL/g; 0.85 to less than 1.0 dL/g; 0.90 to 1.50 dL/g; 0.90 to 1.40 dL/g; 0.90 to 1.30 dL/g; 0.90 to 1.25 dL/g; 0.90 to 1.20 dL/g; 0.90 to 1.15 dL/g; 0.90 to 1.10 dL/g; 0.90 to 1.05 dL/g; 0.90 to 1.10 dL/g; 1.0 to less than 1.50 dL/g; 1.0 to 1.4 dL/g; 1.0 to less than 1.3 dL/g; 1.0 to less than 1.25 dL/g; 1.0 to 1.20 dL/g; 1.0 to 1.10 dL/g; 1.05 to 1.25 dL/g; 1.05 to less than 1.25 dL/g; 1.05 to 1.20 dL/g; 1.05 to 1.15 dL/g; 1.05 to 1.10 dL/g; greater than 0.80 dL/g to 1.50 dL/g; greater than 0.80 dL/g to 1.40 dL/g; greater than 0.80 dL/g to less than 1.30 dL/g; greater than 0.85 dL/g to 1.30 dL/g; greater than 0.85 dL/g to 1.25 dL/g; greater than 0.85 dL/g to 1.20 dL/g; greater than 0.85 dL/g to 1.15 dL/g; greater than 0.85 dL/g to 1.10 dL/g; greater than 0.85 dL/g to 1.05 dL/g; greater than 0.85 dL/g to 1.0 dL/g; greater than 0.90 dL/g to 1.30 dL/g; greater than 0.95 dL/g to 1.30 dL/g; greater than 1.0 dL/g to 1.30 dL/g.

In certain embodiments, the acid component for the polymeric component (B) or (C) comprising 1,4-cyclohexane dicarboxylate includes but is not limited to at least one of the following combinations of ranges: about 90 to about 100 mole % 1,4-cyclohexane dicarboxylic acid residues; and about 0 to 10 mole % aromatic and/or aliphatic dicarboxylic acid residues having up to 20 carbon atoms; about 90 to about 98 mole % 1,4-cyclohexane dicarboxylic acid residues and about 2 to 10 mole % modifying aromatic and/or aliphatic dicarboxylic acid residues having up to 20 carbon atoms; about 90 to about 95 mole % 1,4-cyclohexane dicarboxylic acid residues and about 5 to 10 mole % modifying aromatic and/or aliphatic dicarboxylic acid residues having up to 20 carbon atoms; about 90 to about 93 mole % 1,4-cyclohexane dicarboxylic acid residues and about 7 to 10 mole % modifying aromatic and/or aliphatic dicarboxylic acid residues having up to 20 carbon atoms; about 92 to about 100 mole % 1,4-cyclohexane dicarboxylic acid residues and about 0 to 8 mole % modifying aromatic and/or aliphatic dicarboxylic acid residues having up to 20 carbon atoms; about 95 to about 100 mole % 1,4-cyclohexane dicarboxylic acid residues and about 0 to 5 mole % modifying aromatic and/or aliphatic dicarboxylic acid residues having up to 20 carbon atoms; about 98 to about 100 mole % 1,4-cyclohexane dicarboxylic acid residues and about 0 to 2 mole % modifying aromatic and/or aliphatic dicarboxylic acid residues having up to 20 carbon atoms; or about 100 mole % 1,4-cyclohexane dicarboxylic acid residues and no modifying aromatic and/or aliphatic dicarboxylic acid residues having up to 20 carbon atoms.

In certain embodiments, the glycol component for the polymeric component (B) or (C) comprising 1,4-cyclohexane dicarboxylate includes but is not limited to at least one of the following combinations of ranges: about 90 to about 100 mole % 1,4-cyclohexanedimethanol residues and about 0 to 10 mole % modifying glycol residues; about 90 to about 98 mole % 1,4-cyclohexanedimethanol residues and about 2 to 10 mole % modifying glycol residues; about 90 to about 95 mole % 1,4-cyclohexanedimethanol residues and about 5 to 10 mole % modifying glycol residues; about 90 to about 93 mole % 1,4-cyclohexanedimethanol residues and about 7 to 10 mole % modifying glycol residues; about 92 to about 100 mole % 1,4-cyclohexanedimethanol residues and about 0 to 8 mole % modifying glycol residues; about 95 to about 100 mole % 1,4-cyclohexanedimethanol residues and about 0 to 5 mole % modifying glycol residues; about 98 to about 100 mole % 1,4-cyclohexanedimethanol residues and about 0 to 2 mole % modifying glycol residues; or about 100 mole % 1,4-cyclohexanedimethanol residues and no modifying glycol residues.

In embodiments, the component (B) or (C) comprising 1,4-cyclohexane dicarboxylate has an inherent viscosity (IV) in a range from 0.70 to 1.5 dL/g, or 0.75 to 1.3 dL/g, or 0.8 to 1.2 dL/g, 0.8 to 1.1 dL/g, or 0.85 to 1.1 dL/g, or 0.85 to 1.0 dL/g, as determined in 60/40 (wt/wt) phenol/tetrachloroethane at a concentration of 0.5 g/100 ml at 25° C. In embodiments, the component (B) or (C) comprising 1,4-cyclohexane dicarboxylate has a glass transition temperature (Tg) or less than 110° C., or less than 100° C., or less than 90° C., or less than 80° C., or in the range from 30° C. to 100° C., or 40° C. to 90° C., 50° C. to 80° C., or 60° C. to 75° C., measured by DSC. In embodiments, the component (B) or (C) comprising 1,4-cyclohexane dicarboxylate has an elongation at break of at least 50%, or at least 75%, or at least 100%, or in the range of 50% to 300%, or 100% to 200%, measured according to ASTM D 638; and/or a flexural modulus in the range of 500 to 2000 MPa, or 750 to 1500 MPa, or 800 to 1200 MPa, measured according to ASTM D 790; and/or a tear strength of at least 10 N, or at least 50 N, or at least 100 N, or in the range from 10 N to 200 N, or 10 N to 150 N, or 10 N to 100 N, measured according to ASTM D 1004.

In embodiments, the polymeric component (B) or (C) can comprise a polyesterether or copolyester ether (COPE), e.g., (PCCE) commercially available, for example, from Eastman Chemical Company. The term “polyesters” as used herein with respect to component (B) or (C), is intended to include copolyesterethers. The copolyesterethers can be derived from a dicarboxylic acid component comprising and/or consisting essentially of 1,4-cyclohexanedicarboxylic acid or an ester forming derivative thereof such as dimethyl-1,4-cyclohexanedicarboxylate. This acid and ester are both sometimes referred to herein as DMCD. The diol component consists essentially of 1,4-cyclohexanedimethanol (CHDM) and polytetramethylene ether glycol (PTMG). The copolyesterethers further can comprise branching agents, for example, from about 0.1 to about 1.5 mole %, based on the acid or glycol component, of a polyfunctional branching agent having at least 3 carboxyl or hydroxyl groups.

In embodiments, the dibasic acid component of the copolyesterether comprises residues of 1,4-cyclohexanedicarboxylic acid or dimethyl-1,4-cyclohexanedicarboxylate having a trans isomer content of at least 70% or at least 80% or at least 85%. In an embodiment, the dibasic acid component of the copolyesterether can consist essentially of DMCD and can have a trans isomer content of at least 70%, or at least 80% or at least 85%.

In embodiments, the polyesterether useful in the core or inner layer can comprise residues of 1,4-cyclohexanedicarboxylic acid or an ester thereof in the amount of from 70-100 weight % or from 80 to 100 weight % or from 90 to 100 weight % or from 95 to 100 weight % or from 98 to 100 weight %, based on a total of 100 weight % acid residues and a total of 100 weight % diol residues. The polyesterether can comprise residues of 1,4-cyclohexanedimethanol and polytetramethylene ether glycol.

In certain embodiments, the polyesterether can comprise residues of from 1 to 50 mole %, or 5 to 50 mole %, or 10 to 50 mole %, or 15 to 50 mole %, or 20 to 50 mole % or 25 to 50 mole %, or 30 to 50 mole %, or 35 to 50 mole %, or 40 to 50 mole %, or 45 to 50 mole %, or 1 to 45 mole %, or 5 to 45 mole %, or 10 to 45 mole %, or 15 to 45 mole %, or 20 to 45 mole % or 25 to 45 mole %, or 30 to 45 mole %, or 35 to 45 mole %, or 40 to 45 mole %, or 1 to 40 mole %, or 5 to 40 mole %, or 10 to 40 mole %, or 15 to 40 mole %, or 20 to 40 mole % or 25 to 40 mole %, or 30 to 40 mole %, or 35 to 40 mole %, or 1 to 35 mole %, or 5 to 35 mole %, or 10 to 35 mole %, or 15 to 35 mole %, or 20 to 35 mole % or 25 to 35 mole %, or 30 to 35 mole %, or 1 to 30 mole %, or 5 to 30 mole %, or 10 to 30 mole %, or 15 to 30 mole %, or 20 to 30 mole % or 25 to 30 mole %, or 1 to 25 mole %, or 5 to 25 mole %, or 10 to 25 mole %, or 15 to 25 mole %, or 20 to 25 mole %, or 1 to 20 mole %, or 5 to 20 mole %, or 10 to 20 mole %, or 15 to 20 mole %, or 1 to 15 mole %, or 5 to 15 mole %, or 10 to 15 mole %, or 1 to 10 mole %, or 5 to 10 mole %, or 1 to 5 mole %, of polytetramethylene ether glycol residues.

In certain embodiments, the polyesterether can comprise residues of from 1 mole % to 20 mole %, or 1 mole % to 15 mole %, or 1 mole % to 12 mole %, or 1 mole % to 10 mole %, or 3 mole % to 12 mole %, or from 5 mole % to 10 weight %, or from 7 to 10 mole %, of polytetramethylene ether glycol residues.

In one embodiment, the polyester portion of the polyesterether comprises residues of at least one glycol as described for the polyesters useful in the invention. In certain embodiments, the polyester portion of the polyesterether comprises residues of at least one glycol selected from ethylene glycol, diethylene glycol, triethylene glycol, isosorbide, propane-1,3-diol, butane-1,4-diol, 2,2-dimethylpropane-1,3-diol (neopentyl glycol), 2,2,4,4,-tetramethyl-1,3-cyclobutanediol, pentane-1,5-diol, hexane-1,6-diol, 1,4-cyclohexanedimethanol, 3-methyl-pentanediol-(2,4), 2-methylpentanediol-(1,4), 2,2,4-tri-methylpentane-diol-(1,3), 2-ethylhexanediol-(1,3), 2,2-diethylpropane-diol-(1,3), hexanediol-(1,3), 1,4-di-(hydroxyethoxy)-benzene, 2,2-bis-(4-hydroxycyclohexyl)-propane, 2,4-dihydroxy-1, 1,3,3-tetramethyl-cyclobutane, 2,2-bis-(3-hydroxyethoxyphenyl)-propane, 2,2-bis-(4-hydroxypropoxyphenyl)-propane, and mixtures thereof. In embodiments, in addition to polytetramethylene ether glycol (PTMG) residues, the balance of the glycol component of the polyesterether is essentially 1,4-cyclohexanedimethanol (CHDM) residues. In embodiments, the glycol component of the polyesterether comprises less than 10 mole %, or less than 5 mole %, or less than 2 mole %, or less than 1 mole %, of glycol residues other than residues of CHDM and PTMG.

In embodiments, the polyesterether can comprise residues of from 50 weight % to 95 weight %, or from 55 weight % to 95 weight %, or from 60 weight % to 95 weight %, or from 70 weight % to 95 weight %, or from 75 weight % to 95 weight %, or from 80 weight % to 95 weight %, of 1,4-cyclohexanedimethanol residues. In embodiment, the polyesterether does not contain residues of ethylene glycol.

In embodiments, the component (B) or (C) comprises a polyesterether having an inherent viscosity (IV) in a range from 0.70 to 1.5 dL/g, or 0.8 to 1.4 dL/g, or 0.9 to 1.3 dL/g, 1.0 to 1.2 dL/g, or 1.1 to 1.2 dL/g, or 1.14 to 1.18 dL/g, as determined in 60/40 (wt/wt) phenol/tetrachloroethane at a concentration of 0.5 g/100 ml at 25° C. In embodiments, the polyesterether has a glass transition temperature (Tg) or less than 0° C., or less than −10° C., or less than −20° C., or less than −30° C., or in the range from −60° C. to 0° C., or −50° C. to −10° C., −60° C. to −20° C., or −50° C. to −30° C., measured by DSC. In embodiments, the polyesterether has an elongation at break of at least 200%, or at least 300%, or at least 350%, or in the range of 200% to 600%, or 300% to 500%, measured according to ASTM D 638; and/or a flexural modulus in the range of 50 to 250 MPa, or 100 to 200 MPa, measured according to ASTM D 790; and/or a tear strength of at least 200 N, or at least 250 N, or at least 300 N, or in the range from 200 N to 500N, or 250 N to 450 N, or 300 N to 400 N, measured according to ASTM D 1004.

In one embodiment, copolyesterether contained in the component (B) or (C) can have an inherent viscosity of from about 0.70 to about 1.5 dL/g as determined in 60/40 (wt/wt) phenol/tetrachloroethane at a concentration of 0.5 g/100 ml at 25° C. and can comprise:
A. a dicarboxylic acid component comprising and/or consisting essentially of 1,4-cyclohexanedicarboxylic acid, and
B. a glycol component consisting essentially of
   (1) 1,4-cyclohexanedimethanol, and
   (2) from about 1 to about 50 mole percent, or from 1 to 20 mole percent, or from 1 to 15 mole percent, or from 2 to 10 mole percent, based on the moles of the glycol component of the polyesterether, of polytetramethyleneether glycol (PTMG) having a weight average molecular weight of about 500 to about 2000.

In one embodiment, the copolyesterether can further comprise (3) from about 0.1 to about 1.5 mole %, or 0.1 to 1.0 mole % based on the total mole % of the acid or glycol component, of a branching agent having at least three COOH or OH functional groups and from 3 to 60 carbon atoms.

The relative amounts of each component containing polyesters according to various embodiments (in the multicomponent composition) is described below. For purposes of this application: “TMCD and CHDM polyester” refers to any of the embodiments described herein for polyesters containing both TMCD and CHDM residues in the diol component of the polyester; “TMCD and EG polyester” refers to any of the embodiments described herein for polyesters containing both TMCD and EG residues in the diol component of the polyester; “isosorbide polyester” refers to any of the embodiments described herein for polyesters containing isosorbide residues in the diol component of the polyester; “1,4-cyclohexane dicarboxylate polyester” refers to any of the embodiments described herein for polyesters containing 1,4-cyclohexane dicarboxylate residues in the diacid component of the polyester; and “polyesterether” refers to any of the embodiments described herein for polyesters containing a polyesterether in the diol component of the polyester.

In embodiments, the multicomponent composition comprises polymeric component (A) containing a TMCD and CHDM polyester, or a TMCD and EG polyester, and component (B) containing a 1,4-cyclohexane dicarboxylate polyester in one or the following amounts: 50 to 99 wt % component (A) and 1 to 50 wt % component (B), or greater than 50 to 99 wt % component (A) and 1 to less than 50 wt % component (B), or 55 to 99 wt % component (A) and 1 to 45 wt % component (B), or 60 to 99 wt % component (A) and 1 to 40 wt % component (B), or 65 to 99 wt % component (A) and 1 to 35 wt % component (B), or 70 to 99 wt % component (A) and 1 to 30 wt % component (B), or 75 to 99 wt % component (A) and 1 to 25 wt % component (B), or 80 to 99 wt % component (A) and 1 to 20 wt % component (B), or 55 to 95 wt % component (A) and 5 to 45 wt % component (B), or 60 to 95 wt % component (A) and 5 to 40 wt % component (B), or 65 to 95 wt % component (A) and 5 to 35 wt % component (B), or 70 to 95 wt % component (A) and 5 to 30 wt % component (B), or 75 to 95 wt % component (A) and 5 to 25 wt % component (B), or 80 to 95 wt % component (A) and 5 to 20 wt % component (B), or 55 to 90 wt % component (A) and 10 to 45 wt % component (B), or 60 to 90 wt % component (A) and 10 to 40 wt % component (B), or 65 to 90 wt % component (A) and 10 to 35 wt % component (B), or 70 to 90 wt % component (A) and 10 to 30 wt % component (B), or 75 to 90 wt % component (A) and 10 to 25 wt % component (B), or 80 to 90 wt % component (A) and 10 to 20 wt % component (B). In embodiments, the multicomponent composition comprises component (B) containing a 1,4-cyclohexane dicarboxylate polyester in an amount ranging from 30 to 50 wt %, or 30 to less than 50 wt %, or 35 to 45 wt %. In embodiments, this range of component B can provide a unique balance of tear resistance, modulus and force retention properties.

In embodiments, the multicomponent composition comprises polymeric component (A) containing a TMCD and CHDM polyester, or a TMCD and EG polyester, and component (B) containing a polyesterether in one or the following amounts: greater than 50 to 99 wt % component (A) and 1 to less than 50 wt % component (B), or 55 to 99 wt % component (A) and 1 to 45 wt % component (B), or 60 to 99 wt % component (A) and 1 to 40 wt % component (B), or 65 to 99 wt % component (A) and 1 to 35 wt % component (B), or 70 to 99 wt % component (A) and 1 to 30 wt % component (B), or 75 to 99 wt % component (A) and 1 to 25 wt % component (B), or 80 to 99 wt % component (A) and 1 to 20 wt % component (B), or 55 to 95 wt % component (A) and 5 to 45 wt % component (B), or 60 to 95 wt % component (A) and 5 to 40 wt % component (B), or 65 to 95 wt % component (A) and 5 to 35 wt % component (B), or 70 to 95 wt % component (A) and 5 to 30 wt % component (B), or 75 to 95 wt % component (A) and 5 to 25 wt % component (B), or 80 to 95 wt % component (A) and 5 to 20 wt % component (B), or 55 to 90 wt % component (A) and 10 to 45 wt % component (B), or 60 to 90 wt % component (A) and 10 to 40 wt % component (B), or 65 to 90 wt % component (A) and 10 to 35 wt % component (B), or 70 to 90 wt % component (A) and 10 to 30 wt % component (B), or 75 to 90 wt % component (A) and 10 to 25 wt % component (B), or 80 to 90 wt % component (A) and 10 to 20 wt % component (B).

In embodiments, the multicomponent composition comprises polymeric component (A) containing an isosorbide polyester and component (B) containing a polyesterether in one or the following amounts: greater than 50 to 99 wt % component (A) and 1 to less than 50 wt % component (B), or 55 to 99 wt % component (A) and 1 to 45 wt % component (B), or 60 to 99 wt % component (A) and 1 to 40 wt % component (B), or 65 to 99 wt % component (A) and 1 to 35 wt % component (B), or 70 to 99 wt % component (A) and 1 to 30 wt % component (B), or 75 to 99 wt % component (A) and 1 to 25 wt % component (B), or 80 to 99 wt % component (A) and 1 to 20 wt % component (B), or 55 to 95 wt % component (A) and 5 to 45 wt % component (B), or 60 to 95 wt % component (A) and 5 to 40 wt % component (B), or 65 to 95 wt % component (A) and 5 to 35 wt % component (B), or 70 to 95 wt % component (A) and 5 to 30 wt % component (B), or 75 to 95 wt % component (A) and 5 to 25 wt % component (B), or 80 to 95 wt % component (A) and 5 to 20 wt % component (B), or 55 to 90 wt % component (A) and 10 to 45 wt % component (B), or 60 to 90 wt % component (A) and 10 to 40 wt % component (B), or 65 to 90 wt % component (A) and 10 to 35 wt % component (B), or 70 to 90 wt % component (A) and 10 to 30 wt % component (B), or 75 to 90 wt % component (A) and 10 to 25 wt % component (B), or 80 to 90 wt % component (A) and 10 to 20 wt % component (B).

In certain embodiments, the polymeric component (A) as described herein is a minority component of the multicomponent composition. In such embodiments, the majority component can be polymeric component (B) as described in any of the embodiments herein.

In certain embodiments, the multicomponent composition forms or is contained in one or more layers in a multiple layer structure film. In embodiments, the multiple layer structure film is a three-layer structure having a core layer and two outer layers, one on each side of the core layer. In embodiments, the core layer contains the multicomponent composition and the outer layers are made from other polymeric compositions. In embodiments, at least one of the outer layers contains the multicomponent composition and the core layer is made from another polymeric composition.

As noted above, the overall thickness of the film can range from about 100 μM to about 3000 μM, or about 300 μM to about 3000 μM. In other embodiments, the thickness of the sheet ranges from about 380 μM to about 1600 μM, or about 500 μM to 1000 μM.

The multicomponent composition film can be produced by compounding and extrusion as well as other methods.

In embodiments for a film structure having at least three layers, the thickness of the core layer can range from about 1 μM to about 1000 μM. In certain embodiments, the thickness of the core layer ranges from about 1 μM to about 725 μM, or 1 μM to 600 μM. In certain embodiments, the thickness of the outer layers each individually range from about 1 μM to about 2000 μM. In a further embodiment, the outer layer thickness ranges from about 25 μM to about 2000 μM.

Multilayer films can be produced by co-extrusion, extrusion laminating, heat laminating, adhesive laminating and the like. In co-extrusion multiple layers of polymers are generated by melting the polymer compositions for each layer in different extruders which are fed into a coextrusion block or die. A multi-layer sheet or film is formed in the block or die. Extrusion laminating is a process in which at least two sheets or films (monolayer or co-ex) are bonded together by extruding a polymer melt between them, creating a multilayer structure. Adhesive laminating takes at least two sheets or films (monolayer or co-ex) and bonds them together using a liquid adhesive to create a multilayer sheet or film. Heat laminating is a batch process in which cut sheets or films of various compositions or structures are laid up in a heated press. Multiple combinations and multiple layers can be made using these methods.

In the event a multilayer film having a core and outer layers as described herein tend to separate or delaminate from each other during processing or usage, at least one intermediate “tie layer” may be utilized between such layers. In one embodiment, the multilayer film has at least five film layers comprising one-core layer A and two outer layers B, with one-layer B one each side of the core layer A and a tie layer between the layer A and each layer B, i.e., “B-tie-A-tie-B”. In certain embodiments, such tie layers can comprise one or more copolymers selected from polyethylene copolymers, polypropylene copolymers, anhydride modified polyolefins, acid/acrylate modified ethylene vinyl acetate copolymer, acid modified ethylene acrylate, anhydride modified ethylene acrylate, modified ethylene acrylate, modified ethylene vinyl acetate, anhydride modified ethylene vinyl acetate copolymer, anhydride modified high density polyethylene, anhydride modified linear low density polyethylene, anhydride modified low density polyethylene, anhydride modified polypropylene, ethylene ethyl acrylate maleic anhydride copolymer and ethylene butyl acrylate maleic anhydride terpolymer, ethylene-alpha-olefin copolymers, alkene-unsaturated carboxylic acid or carboxylic acid derivative copolymers, ethylene-methacrylic acid copolymers, ethylene-vinyl acetate copolymers, ethylene-methacrylic acid copolymers, unsaturated dicarboxylic acid anhydride grafted copolymers, maleic anhydride grafted ethylene-vinyl acetate copolymers, maleic anhydride grafted polyethylene, styrene-butadiene copolymers, C3 or higher alpha-olefin copolymers having a high alpha-olefin comonomer content, propylene-1-butene copolymers, and mixtures thereof.

In embodiments, the film (e.g., mono-layer or multilayer film, depending on the embodiment) has a tear force of at least 10 N, or at least 20 N, or at least 30 N, or at least 40 N, or at least 50 N, or at least 60 N, or in a range from 10 N to 100 N, or 20 N to 100 N, or 40 N to 100 N, or 50 N to 90 N, or 60 N to 80 N, measured according to ASTM D 1938; and/or a force retention of 70% or less, or 50% or less, or a range of 10 to 70%, or 10 to 50%, or 20 to 50%, or 20 to 40%, measured as described in the examples herein; and/or a flexural modulus greater than 1000 MPa, or at least 1200 MPa, or at least 1500 MPa, or in the range of greater than 1000 to 2200 MPa, or greater than 1200 to 2000 MPa, or greater than 1500 to 2000 MPa, or 1600 to 2000 MPa, or 1600 to 1800 MPa, measured according to ASTM D 790. In embodiments, the multilayer sheet has both the tear force and force retention properties described above. In embodiments, the film has each of the tear force, force retention and flexural modulus properties described above. In embodiments, the film has a total thickness in the range from 100 to 1050 microns, or 500 to 1050 microns, or 500 to 1000 microns, or 600 to 900 microns, or 600 to 800 microns, or 635 microns (25 mils) to 889 microns (35 mils), or 635 microns (25 mils) to 762 microns (30 mils). In embodiments for a multilayer film, the thickness of the inner (or core layer) can be from 10 to 50%, or 15 to 45%, or 20 to 40%, or 20 to 35%, or 25 to 35% of the total thickness of the multilayer film.

Due to its structure as having customizable modulus and superior tear resistance, the films are useful in preparing removable orthodontic tooth positioning appliances, insofar as the films possess sufficiently high modulus and superior tear resistance. See for example, U.S. Pat. Nos. 9,655,691; 9,655,693; and 10,052,176, incorporated herein by reference.

Accordingly, in a further embodiment, the invention provides a removable orthodontic tooth positioning appliance having teeth receiving cavities shaped to directly receive at least some of a patient's teeth, said appliance comprising a polymer structure formed from a film comprising a multicomponent composition comprising at least two polymeric components (A) and (B), wherein polymeric component (A) is present in an amount from greater than 50 to 99 wt % and polymeric component (B) is present in an amount from 1 to less than 50 wt %; and wherein
polymeric component (A) comprises a polyester that comprises:
   (a) a dicarboxylic acid component comprising:
      i) 70 to 100 mole % of terephthalic acid residues; and
      ii) 0 to 30 mole % of aromatic and/or aliphatic dicarboxylic acid residues having up to 20 carbon atoms; and
   (b) a glycol component comprising:
      i) 10 to 50 mole % of 2,2,4,4-tetramethyl-1,3-cyclobutanediol residues;
      ii) 0 to 90 mole % of 1,4-cyclohexanedimethanol residues; and
      iii) O to 90 mole % of ethylene glycol residues; and
having an inherent viscosity of about 0.4 to about 0.9 dL/g as determined in 60/40 (wt/wt) phenol/tetrachloroethane at a concentration of 0.5 g/100 ml at 25° C.; and
polymeric component (B) comprises a polyester which is other than the polyester in polymeric component (A), and wherein the overall thickness of the film is between 100 and 3000 microns, or 300 and 3000 microns.

In a further embodiment, said polymeric component (A) comprises a polyester comprising:
(a) a dicarboxylic acid component comprising:
   i) 90 to 100 mole % of terephthalic acid residues;
   ii) 0 to 10 mole % of aromatic and/or aliphatic dicarboxylic acid residues having up to 20 carbon atoms; and
(b) a glycol component comprising:
   i) 10 to 40 mole % of 2,2,4,4-tetramethyl-1,3-cyclobutanediol residues;
   ii) 60 to 90 mole % of 1,4-cyclohexanedimethanol residues; and
has an inherent viscosity of about 0.5 to about 0.9 dL/g as determined in 60/40 (wt/wt) phenol/tetrachloroethane at a concentration of 0.5 g/100 ml at 25° C.

In a further embodiment, said polymeric component (A) comprises a polyester comprising:
(a) a dicarboxylic acid component comprising:
   (i) 90 to 100 mole % of terephthalic acid residues;
   ii) 0 to 10 mole % of aromatic and/or aliphatic dicarboxylic acid residues having up to 20 carbon atoms; and
(b) a glycol component comprising:
   i) 10 to 40 mole % of 2,2,4,4-tetramethyl-1,3-cyclobutanediol residues;
   ii) 60 to 90 mole % of ethylene glycol residues; and p1 has an inherent viscosity of about 0.4 to about 0.9 dL/g as determined in 60/40 (wt/wt) phenol/tetrachloroethane at a concentration of 0.5 g/100 ml at 25° C. In a further embodiment, the inherent viscosity of the polymeric component (A) is between about 0.5 and 0.7 dL/g.

In embodiments, the film comprising a multicomponent composition used to form the appliance can include any of the film embodiments described herein and any of the combinations of polymeric components (A) and (B) for two (or more) component compositions or any of the combinations of polymeric components (A), (B) and (C) for three (or more) component compositions.

In a further embodiment, the invention provides a removable orthodontic tooth positioning appliance having teeth receiving cavities shaped to directly receive at least some of a patient's teeth, said appliance comprising a multi-layer polymer structure formed from a film comprising two outer layers and at least one core layer, wherein at least one layer comprises the multicomponent composition described herein.

In embodiments, the dental appliance can be made from any of the monolayer or multilayer films described herein.

This invention can be further illustrated by the following examples of certain embodiments thereof, although it will be understood that these examples are included merely for purposes of illustration and are not intended to limit the scope of the invention unless otherwise specifically indicated.

### EXAMPLES

The following examples are provided illustrate certain embodiments of the invention.

### Test Methods

The tensile properties of the examples were determined using a test method derived from ASTM D882. Small Type V tensile bars were cut from the film. Samples were conditioned for at least 40 hours and tested at 23° C./50% relative humidity unless otherwise stated. A crosshead speed of 1.27 mm/min is used.

The flexural properties of the examples were determined using a test method derived from ASTM D790 Procedure A. Films are conditioned for 24 hours and tested at 23° C./50% relative humidity unless otherwise stated. A crosshead speed of 1.27 mm/min is used.

The tear force of the examples was determined using a test method derived from ASTM D1938. Films are conditioned for 24 hours and tested at 23° C./50% relative humidity unless otherwise stated. Load is applied at 250 mm per minute.

The stress relaxation properties of the examples were analyzed using dynamic mechanical analysis (DMA) in tensile mode on a film sample of thickness 0.7-0.8 mm and width of 3.1-3.3 mm. The samples were held for 24 hours at 0.5% strain, during which time the stress was monitored. This testing was performed at 37° C. with a relative humidity of 90-100% (which can include testing while submerged in water).

The hardness of the examples was determined using a test method derived from ASTM D2240. Samples were conditioned for at least 40 hours and tested at 23° C./50% relative humidity unless otherwise stated.

### EXAMPLES

Materials used in the examples included:
R1—Tritan Copolyester MP100 (Eastman Chemical Company)
R2—Neostar 19972 elastomer (Eastman Chemical Company)
R3—Ecdel 9966 elastomer (Eastman Chemical Company)
M1—Kane Ace MV-01 core-shell impact modifier (Kaneka)

### Example 1

Example 1 was performed by blending R1 with two different polyesters in different amounts. Examples 1-1 through 1-4 were blends of R1 with 15, 30, 40, and 50 wt % R2, respectively. Examples 1-5 and 1-6 were blends of R1 with 15 and 30 wt % R3, respectively.

### Example 2

Example 2 was performed using unblended R1 and also blending R1 with a core-shell polymeric impact modifier in different amounts. Examples 2-1 was unblended (or neat) R1. Examples 2-2 to 2-4 were blends of R1 with M1 at 3, 4 and 5 wt % loading, respectively.

All blends were compounded on a 26 mm twin-screw extruder and strand-pelletized prior to film extrusion. Compounding barrel and die temperatures ranged from 260-270° C. Film samples were extruded on a 1.5″ single-screw extruder with target film thickness of 0.7-0.8 mm. Film extrusion barrel temperature was 260-270° C. All materials were dried prior to compounding and extrusion. Properties provided were tested using the methods outlined in the “Test Conditions” described above. The results for example 1 are listed below in Table 1 and the results for example 2 are listed below in Table 2.

TABLE 1
Properties for Example 1

| | | EX 1-1 | 1-2 | 1-3 | 1-4 | 1-5 | 1-6 |
|---|---|---|---|---|---|---|---|
| Tensile Properties | Yield Stress, | 38.1 | 38.1 | 38.4 | 37.3 | 36.1 | 33.6 |
| | MPa | | | | | | |
| | Yield Strain, % | 4.6 | 4.5 | 4.4 | 4.3 | 5.4 | 5.7 |
| | Break Stress, | 49.9 | 49.2 | 49.3 | 46.5 | 43.8 | 43.8 |
| | MPa | | | | | | |
| | Break Strain, % | 126 | 145 | 159 | 166 | 110 | 134 |
| | Young's | 1321 | 1299 | 1309 | 1197 | 1054 | 951 |
| | Modulus, MPa | | | | | | |
| Flexural Properties | Stress at Yield, | 43.9 | 41.2 | 42.7 | 42.1 | **** | 40.7 |
| | MPa | | | | | | |
| | Strain at Yield, | 3.0 | 2.9 | 3.1 | 3.1 | **** | 3.6 |
| | % | | | | | | |
| | Modulus, MPa | 1672 | 1758 | 1627 | 1552 | 1595 | 1322 |
| Color | L* | 96.8 | 96.7 | 96.9 | 96.9 | 85.2 | 80.1 |
| | a* | 0.01 | 0.0 | 0.0 | 0.02 | 1.38 | 1.03 |
| | b* | 0.47 | 0.52 | 0.53 | 0.62 | 10.36 | 8.05 |
| | % Haze | 0.61 | 0.33 | 0.33 | 1.2 | 59.8 | 96.6 |
| Force | Starting Force | 14.5 | 13.9 | 13.7 | 13.4 | 12.6 | 9.1 |
| Retention | (N) | | | | | | |
| | % Retention | 26% | 21% | 19% | 16% | 25% | 12% |
| | (90% RH) | | | | | | |
| Hardness | Shore D | 79 | 78 | 77 | 77 | 73 | 73 |
| Trouser | Average Tear | 2165.1 | 2590.9 | 2804.3 | 2965.8 | 2184.4 | 1249.7 |
| Tear | Load, gf | | | | | | |
| Force | Average Tear | 21.2 | 25.4 | 27.5 | 29.1 | 21.4 | 12.3 |
| | Load, N | | | | | | |
| | Avg Tear | 27.9 | 33.2 | 37.2 | 38.2 | 29.4 | 16.4 |
| | Propagation | | | | | | |
| | Resist (N/mm) | | | | | | |
| | Total Energy, | 101.0 | 120.6 | 126.8 | 139.5 | 95.0 | 56.7 |
| | kg*mm | | | | | | |

A review of Table 1 reveals that blending R2 and R3 into R1 can provide the ability to tune certain properties such as modulus, tear resistance, and force relaxation depending on the specific application needs. Examples 1-2 to 1-4 resulted in a significant increase in tear resistance, while maintaining a balance of modulus and force retention.

TABLE 2
Properties for Example 2

| | | 2-1 | 2-2 | 2-3 | 2-4 |
|---|---|---|---|---|---|
| Tensile | Yield Stress, MPa | 45.3 | 42.3 | 42.5 | 42.2 |
| Properties | Yield Strain, % | 5.2 | 5.7 | 5.4 | 5.4 |
| | Break Stress, MPa | 60.1 | 54.1 | 53.7 | 51.5 |
| | Break Strain, % | 92 | 112 | 113 | 108 |
| | Young's Modulus, MPa | 1329 | 1249 | 1293 | 1273 |
| Flexural | Stress at Yield, MPa | 149.4 | **** | **** | **** |
| Properties | Strain at Yield, % | 3.74 | **** | **** | **** |
| | Modulus, MPa | 2077 | 2102 | 2120 | 2119 |
| Color | L* | 96.2 | 95.9 | 95.7 | 95.3 |
| | a* | −0.04 | 0.10 | 0.14 | 0.22 |
| | b* | 0.41 | 1.25 | 1.45 | 1.77 |
| | % Haze | 0.89 | 3.78 | 3.93 | 4.49 |
| Force | Starting Force (N) | 11.8 | 15.2 | 15.1 | 16.8 |
| Retention | % Retention (90% RH) | 65 | 44 | 51 | 44 |
| Hardness | Shore D | 78 | 77 | 77 | 77 |
| Trouser | Average Tear Load, gf | 2233.2 | 2501.8 | 2371.8 | 2130.6 |
| Tear | Average Tear Load, N | 21.9 | 24.5 | 23.3 | 20.9 |
| Force | Avg Tear Propagation | 27.7 | 31.0 | 29.7 | 27.0 |
| | Resist (N/mm) | | | | |
| | Total Energy, kg*mm | 104.6 | 86.8 | 87.7 | 93.0 |

A review of Table 2 reveals that the addition of M1 has less effect on changing certain properties such as modulus compared to the blends in Table 1.

The invention has been described in detail with particular reference to certain embodiments thereof, but it will be understood that variations and modifications can be affected within the spirit and scope of the invention.

1. A film comprising a multicomponent composition, said multicomponent composition comprising at least two polymeric components (A) and (B),
wherein polymeric component (A) is present in an amount from 50 to 99 wt % and polymeric component (B) is present in an amount from 1 to 50 wt %; and wherein polymeric component (A) comprises a polyester that comprises:
(a) a dicarboxylic acid component comprising:
i) 70 to 100 mole % of terephthalic acid residues; and
ii) 0 to 30 mole % of aromatic and/or aliphatic dicarboxylic acid residues having up to 20 carbon atoms; and
(b) a glycol component comprising:
i) 10 to 50 mole % of 2,2,4,4-tetramethyl-1,3-cyclobutanediol residues;
ii) 0 to 90 mole % of 1,4-cyclohexanedimethanol residues; and
iii) 0 to 90 mole % of ethylene glycol residues; and having an inherent viscosity of about 0.4 to about 0.9 dL/g as
determined in 60/40 (wt/wt) phenol/tetrachloroethane at a concentration of 0.5 g/100 ml at 25° C.; and
polymeric component (B) comprises a polyester which is other than the polyester in polymeric component (A); wherein said polymeric component (B) comprises a polyester that comprises: (a) a dicarboxylic acid component comprising residues of 1,4-cyclohexane dicarboxylate, and (b) a diol component comprising residues of 1,4-cyclohexanedimethanol; and wherein the overall thickness of the film is between 100 and 3000 microns.

2. (canceled)

3. The film according to claim 1, wherein said polymeric component (B)
comprises a polyester that comprises:
(a) a dicarboxylic acid component comprising:
i) 90 to 100 mole % of 1,4-cyclohexane dicarboxylic acid residues;
ii) 0 to 10 mole % of aromatic and/or aliphatic dicarboxylic acid residues having up to 20 carbon atoms;
and
(b) a glycol component comprising:
i) 90 to 100 mole % of 1,4-cyclohexanedimethanol residues, and
ii) 0 to 10 mole % of modifying glycol residues; and
having an inherent viscosity of about 0.5 to about 1.2 dL/g as determined in 60/40 (wt/wt) phenol/tetrachloroethane at a concentration of 0.5 g/100 ml at 25° C.

4. The film according to claim 1, wherein said polymeric component (B) comprises a copolyester that comprises:
a polyester segment and a polyether segment, wherein:
the polyester segment comprises residues of an aliphatic diol and either an aliphatic dicarboxylic acid or an ester of an aliphatic dicarboxylic acid, and
the polyether segment comprises a polyalkylene glycol; and
wherein the copolyester ether has an inherent viscosity of about 0.6 to about 1.5 dL/g as determined in 60/40 (wt/wt) phenol/tetrachloroethane at a concentration of 0.5 g/100 ml at 25° C.

5. The film according to claim 4, wherein said polymeric component (B) comprises a copolyester that comprises a dicarboxylic acid component
comprising residues of 1,4-cyclohexane dicarboxylate and a diol component comprising residues of 1,4-cyclohexanedimethanol and poly(tetramethylene ether)glycol.

6. The film according to claim 5, wherein said polymeric component (B) comprises a copolyester that comprises:
(a) a dicarboxylic acid component comprising:
i) 90 to100 mole % of 1,4-cyclohexane dicarboxylic acid residues;
ii) 0 to 10 mole % of aromatic and/or aliphatic dicarboxylic acid residues having up to 20 carbon atoms; and
(b) a glycol component comprising:
i) 95 to 80 mole % of 1,4-cyclohexanedimethanol residues, and
ii) 5 to 20 mole % of poly(tetramethylene ether)glycol residues; and
has an inherent viscosity of about 0.9 to about 1.4 dL/g as determined in 60/40 (wt/wt) phenol/tetrachloroethane at a concentration of 0.5 g/100 ml at 25° C.

7. The film according to claim 6, wherein the inherent viscosity of copolyester of polymeric component (B) is from about 1.02 to about 1.26.

8. The film according to claim 1,
wherein the polymeric
component (A) is a polyester that comprises:
(a) a dicarboxylic acid component comprising:
i) 90 to 100 mole % of terephthalic acid residues;
ii) 0 to 10 mole % of aromatic and/or aliphatic dicarboxylic acid residues having up to 20 carbon atoms; and
(b) a glycol component comprising:
i) 10 to 40 mole % of 2,2,4,4-tetramethyl-1,3-cyclobutanediol residues;
ii) 60 to 90 mole % of 1,4-cyclohexanedimethanol residues; and
has an inherent viscosity of about 0.5 to about 0.9 dL/g, or about 0.6 and 0.8 dL/g, as determined in 60/40 (wt/wt) phenol/tetrachloroethane at a concentration of 0.5 g/100 ml at 25° C.

9. The film according to claim 1, wherein the polymeric component (A) is a polyester that comprises:
(a) a dicarboxylic acid component comprising:
i) 90 to 100 mole % of terephthalic acid residues;
ii) 0 to 10 mole % of aromatic and/or aliphatic dicarboxylic acid residues having up to 20 carbon atoms; and
(b) a glycol component comprising:
i) 10 to 40 mole % of 2,2,4,4-tetramethyl-1,3-cyclobutanediol residues;
ii) 60 to 90 mole % of ethylene glycol residues; and has an inherent viscosity of about 0.4 to about 0.9 dL/g, or about 0.5
and 0.7 dL/g, as determined in 60/40 (wt/wt) phenol/tetrachloroethane at a concentration of 0.5 g/100 ml at 25° C.

10. The film according to claim 1, wherein the film has a total thickness from about 300 μM to about 3000 μM.

11. The film according to claim 1, wherein the film has an average tear force of at least 10 N on a film of thickness 0.7 to 0.8 mm, measured according to ASTM D 1938, and a force retention of 70% or less, measured as described in the specification on a film of thickness 0.7 to 0.8 mm.

12. The film according to claim 1, wherein the film has a tear force in a range from 20 N to 100 N on a film of thickness 0.7 to 0.8 mm, measured according to ASTM D 1938, and a force retention in the range of 10 to 80%, measured as described in the specification on a film of thickness 0.7 to 0.8 mm.

13. The film according to claim 1, wherein the film has a flexural modulus below 2100 MPa, measured according to ASTM D 790.

14. The film according to claim 1, wherein the film has a flexural modulus in a range from greater than 500 to 2100 MPa, measured according to ASTM D 790.

15. The film according to claim 1, wherein polymeric component (A) is present in an amount from 50 to 70 wt % and polymeric component (B) is present in an amount from 30 to 50 wt %.

16. The film according to claim 15, wherein polymeric component (A) is present in an amount from greater than 50 up to 70 wt % and polymeric component (B) is present in an amount from 30 to less than 50 wt %.

17. A removable orthodontic tooth positioning appliance having teeth receiving cavities shaped to directly receive at least some of a patient's teeth, said appliance comprising a film according to claim 1.
